(19) United States
(12) Patent Application Publication
(10) Pub. No.: US 2022/0401968 A1
(43) Pub. Date: Dec. 22, 2022

(54) MULTICYCLONE SEPARATOR

(71) Applicant: Foremost Equipment LP, Lloydminster (CA)

(72) Inventor: Michael McCarthy, Okotoks (CA)

(73) Assignee: Foremost Equipment LP, Lloydminster (CA)

(21) Appl. No.: 17/354,858

(22) Filed: Jun. 22, 2021

(51) Int. Cl. B04C 9/00; B04C 3/04; B01D 46/00; B01D 45/16; B01D 50/00; E01H 1/08; B60P 3/22

(52) U.S. Cl. CPC B04C 9/00; B04C 3/04; B01D 46/0049; B01D 45/16; B01D 50/002; E01H 1/0836; B60P 3/2245; B04C 2009/002; B04C 2009/005; B01D 2273/30; B01D 2279/55; E01H 2001/0881

(57) ABSTRACT

A vacuum unit includes a debris tank receiving wet or dry waste. A multi-cyclone separator is coupled to an outlet of the debris tank. The multi-cyclone separator receives the wet or dry waste from the debris tank and the multi-cyclone separator includes a plurality of cyclones. A filter is coupled to the outlet of the multi-cyclone separator and receives exhaust airflow from the multi-cyclone which then flows onto the blower or fan and is vented external to the vacuum unit.

### FIELD OF THE INVENTION

The invention relates to the field of vacuum trucks and in particular to vacuum trucks using a high efficiency cyclonic separating apparatus.

### BACKGROUND

Vacuum trucks are widely used in the oil & gas, municipal, industrial, and utility markets for cleaning and carrying both wet and dry waste material. Industrial vacuum units are typically designed for primarily wet or primarily dry applications. Hydro-excavating and sewer cleaning units are examples of wet applications and vacuum loaders or trenching spoils vacuums are examples of dry applications.

In units designed for dry applications there can be a high dust loading of smaller particles which are not separated out in the debris tank or cyclonic separator. As a result, a large surface area particle filter, like a bag house, is often used to capture this dust before the air flows onto the blower or fan. Including a large surface area particle filter can be a very costly part of the industrial vacuum unit and must be frequently cleaned or replaced, interrupting the vacuum operation.

In units designed for wet applications the solid material is wetted by water introduced into the system and is entrained into water mist or droplets in the air stream. These mist or droplets are large enough that they are effectively separated out in the debris tank and cyclonic separator and a large surface area particle filter is not required upstream of the blower or fan. For this reason, when units designed for wet applications are used in dry applications the particle filter loading downstream of the cyclonic separator can be very high and the filter is subject to heavy fouling that leads to frequent filter service and change out.

In the present state of the art, vacuum trucks designed for dry applications perform poorly in wet applications while vacuum trucks designed for wet applications perform poorly in dry applications. Therefore, there is a need for a method and apparatus for a vacuum truck that obviates or mitigates one or more limitations of the prior art and that may be used effectively in both wet and dry applications.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a high efficiency cyclonic separating apparatus with a plurality of cyclones working in parallel in a single or dual cyclonic separator housing being used in an industrial vacuum unit that may be made mobile by way of mounting on a trailer or a truck chassis.

In accordance with embodiments of the present invention, there is provided a vacuum unit including a debris tank receiving wet or dry waste, a multi-cyclone separator coupled to an outlet of the debris tank where the multi-cyclone separator receives the wet or dry waste from the debris tank and the multi-cyclone separator includes a plurality of cyclones. A filter is coupled to the outlet of the multi-cyclone separator and the filter receives exhaust airflow from the multi-cyclone. A blower is coupled to an outlet of the filer and vents the exhaust airflow external to the vacuum unit.

Further embodiments include a second multi-cyclone separator coupled between the outlet of the multi-cyclone separator and the filter.

Further embodiments include a second multi-cyclone separator coupled in parallel to the multi-cyclone separator.

In further embodiments the plurality of cyclones are fixed at different heights within the multi-cyclone separator.

In further embodiments the plurality of cyclones are fixed at a plurality of heights within the multi-cyclone separator.

In accordance with embodiments of the present invention, there is provided a vacuum unit vehicle including a vehicle having a vacuum unit mounted thereon. The vacuum unit includes a debris tank receiving wet or dry waste, a multi-cyclone separator coupled to an outlet of the debris tank where the multi-cyclone separator receives the wet or dry waste from the debris tank and the multi-cyclone separator includes a plurality of cyclones. A filter is coupled to the outlet of the multi-cyclone separator and the filter receives exhaust airflow from the multi-cyclone and a blower is coupled to an outlet of the filer and vents the exhaust airflow external to the vacuum unit.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 provides an illustration of an industrial vacuum according to an embodiment.

FIG. 2 provides an illustration of dual multi-cyclone separators connected in series in an industrial vacuum according to an embodiment.

FIG. 3 provides an illustration of dual multi-cyclone separators connected in parallel in an industrial vacuum according to an embodiment.

FIG. 4 provides an illustration of a multi-cyclone separator with a bottom section according to an embodiment.

FIG. 5 provides an illustration of a multi-cyclone separator with a truncated bottom section according to an embodiment.

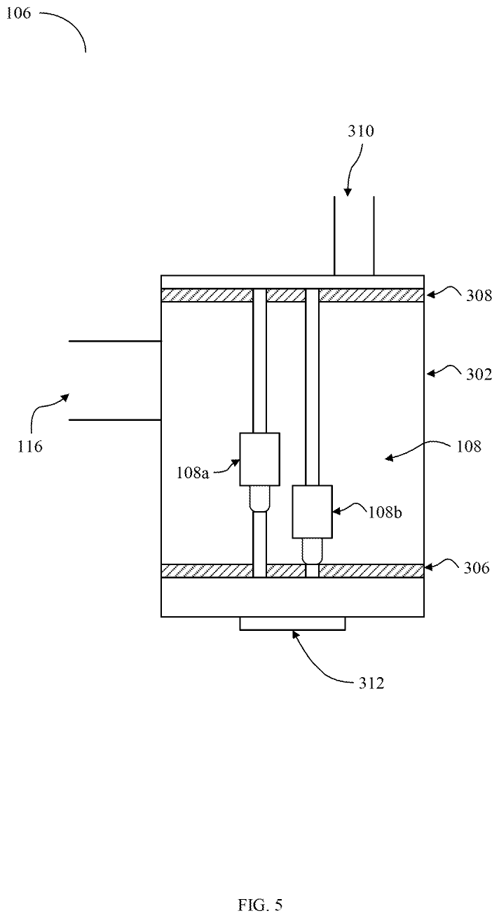

It will be noted that throughout the appended drawings, like features are identified by like reference numerals.

### DETAILED DESCRIPTION

Embodiments of the present invention provide a high efficiency cyclonic separating apparatus with a plurality of cyclones working in parallel in a single or dual cyclonic separator housing being used in an industrial vacuum unit that may be made mobile by way of mounting on a trailer or a truck chassis. Embodiments include a high efficiency cyclonic separating apparatus that allows industrial vacuum units that are designed for wet applications to also operate effectively in dry applications as well. The high efficiency cyclonic separating apparatus also allows industrial vacuum units that are designed for dry applications operate efficiently without the use of a large surface particle filter.

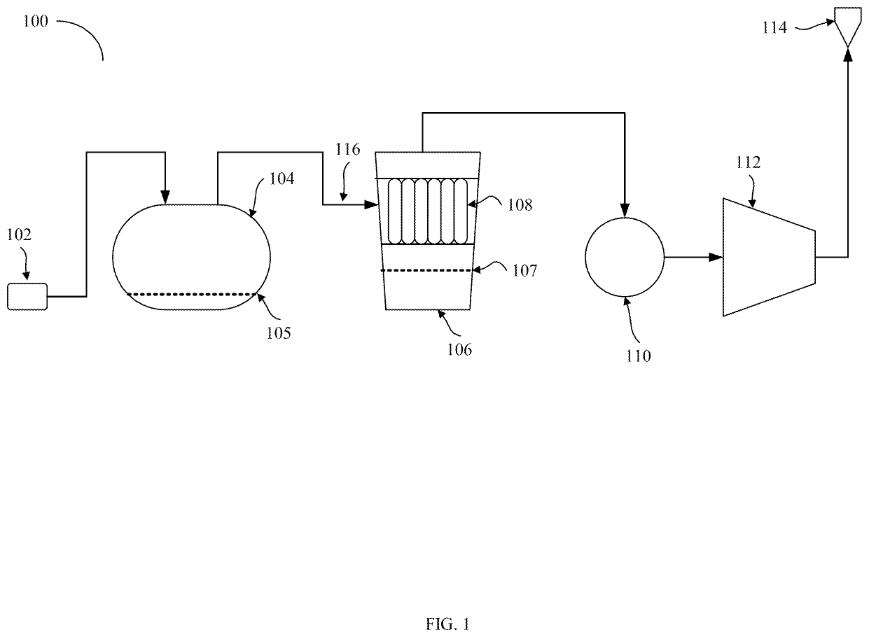

With reference to FIG. 1, industrial vacuum unit 100 receives an airflow 102 which carries dirt and dust, or water and water mist with or without wet solid particles. The airflow 102 enters the unit's debris tank 104 where its velocity is slowed and the larger particles and or droplets fall out of the airstream as a result of gravitational forces and remain in the bottom 105 of debris tank 104. In embodiments a multi-cyclonic separator device 106 is used downstream of the debris tank 104. Cyclone separator 106 includes a multi-cyclone unit 108 that includes a bundle containing a plurality of smaller cyclone units. From the debris tank 104 the airflow is directed to a cyclonic separator 106 via an inlet 116 which causes the airflow to be distributed effectively to the multi cyclone devices 108 within a collecting chamber 107. Inlet 116 may enter the multi-cyclone separator device 106 perpendicular to the wall of cyclone device 106 or at a different angle that allows for airflow entering separator device 106 to be effectively distributed over the multi-cyclone unit 108. Centrifugal forces act on the entrained dirt or liquid as the airflow flows through the multi cyclones 108 and separates it from the air flow. Relatively clean air passes out of the cyclonic separator and flows to a particle filter 110 before flowing to the inlet of the positive displacement blower or the fan 112 that is creating the air flow. The filtered air then exits the vacuum unit 100 through outlet 114.

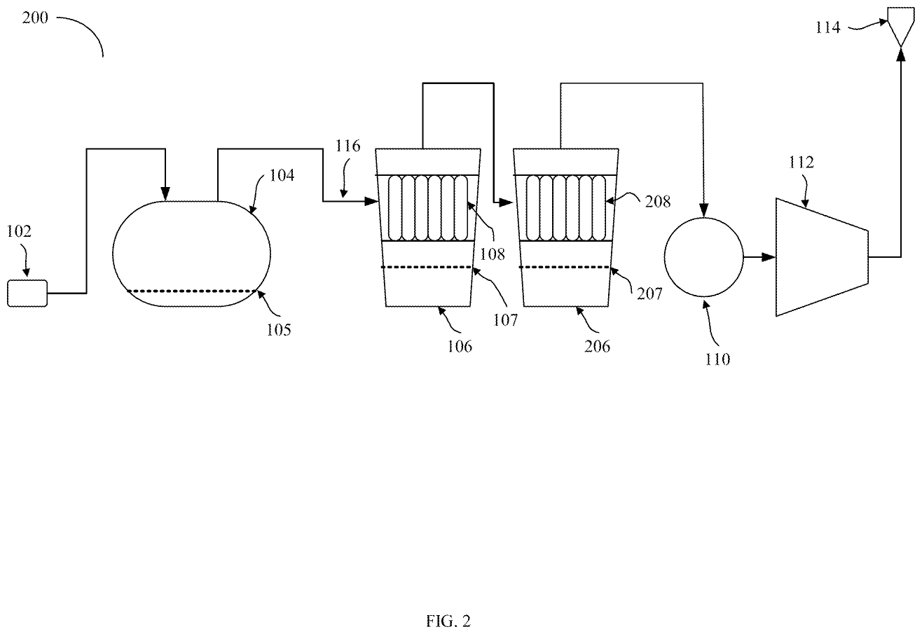

FIG. 2 provides an illustration of dual multi-cyclone separators connected in series in an industrial vacuum according to an embodiment. Industrial vacuum unit 200 receives an airflow 102 which carries dirt and dust, or water and water mist with or without wet solid particles. The airflow 102 enters the unit's debris tank 104 where its velocity is slowed and the larger particles and or droplets fall out of the airstream as a result of gravitational forces and remain in the bottom 105 of debris tank 104. In embodiments a multi-cyclonic separator device 106 is used downstream of the debris tank 104. From the debris tank 104 the airflow is then directed to a cyclonic separator 106 via an inlet 116 which causes the airflow to be distribute effectively to the multi cyclone devices 108 within a collecting chamber 107. Centrifugal forces act on the entrained dirt or liquid as the airflow flows through the multi cyclones 108 and separates it from the air flow. Relatively clean air passes out of the cyclonic separator and to a subsequent multi-cyclonic separator 206, which acts in a similar manner to cyclone separator 106, and then to a particle filter 110 before flowing to the inlet of the positive displacement blower or the fan 112 that is creating the air flow. At least one of cyclone separator 106 and cyclone separator 206 includes a multi-cyclone unit 108 or 208 that includes a bundle of smaller cyclone units. The filtered air then exits the vacuum unit 100 through outlet 114. In embodiments, more than two cyclonic separators may be used in series.

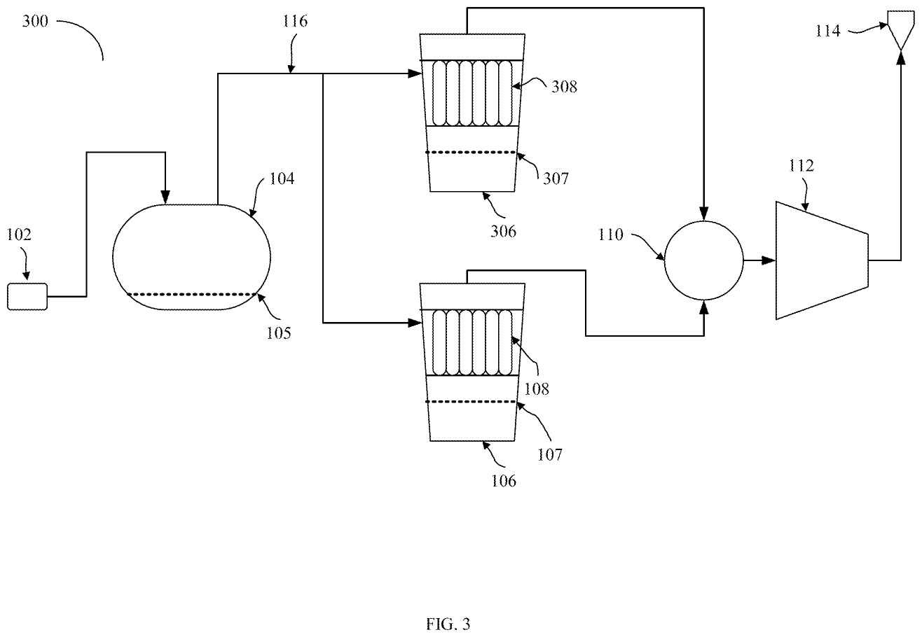

FIG. 3 provides an illustration of dual multi-cyclone separators connected in parallel in an industrial vacuum according to an embodiment. Industrial vacuum unit 300 receives an airflow 102 which carries dirt and dust, or water and water mist with or without wet solid particles. The airflow 102 enters the unit's debris tank 104 where its velocity is slowed and the larger particles and or droplets fall out of the airstream as a result of gravitational forces and remain in the bottom 105 of debris tank 104. In embodiments two multi-cyclonic separator devices 106 and 306 are connected in parallel and used downstream of the debris tank 104. At least one of cyclone separator 106 and cyclone separator 306 includes a multi-cyclone unit 108 or 308 that includes a bundle of smaller cyclone units. From the debris tank 104 the airflow is then directed to cyclonic separator 106 and cyclonic separator 306 via an inlet 116 which causes the airflow to be distribute effectively to the multi cyclone devices 108 and 308 within a collecting chamber 107 and within collecting chamber 307. Centrifugal forces act on the entrained dirt or liquid as the airflow flows through the multi cyclones 108 and 308 and separates it from the air flow. Relatively clean air passes out of the cyclonic separators 106 and 306 and then to a particle filter 110 before flowing to the inlet of the positive displacement blower or the fan 112 that is creating the air flow. The filtered air then exits the vacuum unit 100 through outlet 114.

In embodiments, more than two cyclonic separators may be used in parallel. Additionally, multiple cyclonic separators may be used in both series and parallel arrangements.

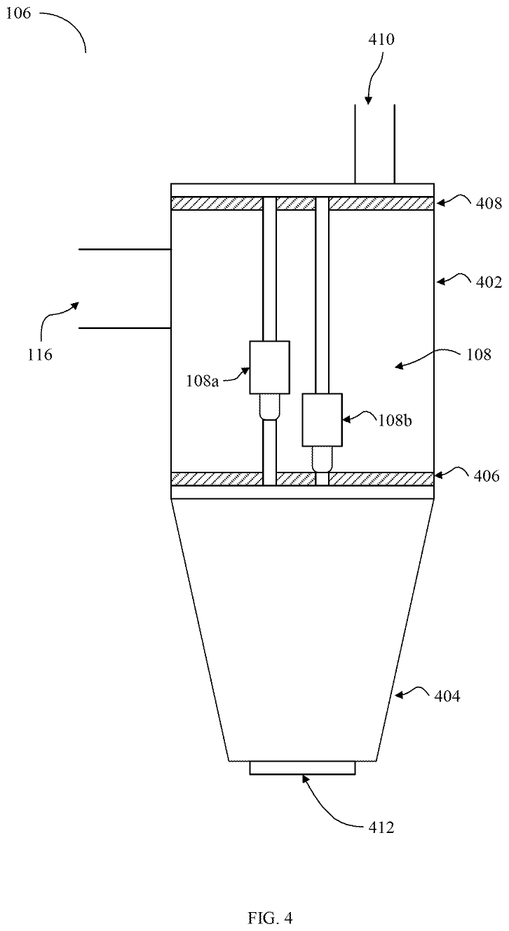

FIG. 4 illustrates a multi-cyclone unit 106 according to an embodiment. Cyclone unit 106 (or 206, 306, or additional cyclone units) includes a housing that includes an upper cylindrical section 402 and a lower section 404. Cylindrical section 402 encloses a space 108 in which a bundle of a plurality of smaller cyclone units 108a and 108b are mounted. Lower section 404 is shaped to connect to cylindrical section 402. A lower section 404 may be cone or cylindrical shaped, truncated cone shaped, or horizontal cylindrical shape and is used to collect waste particles or liquid separated by the plurality of small cyclone units such as 108a or 108b. A bottom hatch or door 412 may be included to remove particles and waste from the cyclone unit 106. The number of small cyclones is constrained by the size of cylindrical section 402 and the size of the individual small cyclones.

The bundle of small cyclones 108a, 108b, . . . , may be mounted between a top plate 408 and bottom plate 406 and distributed within the cylindrical section 402. The bundle of small cyclones may be mounted at the same or offset levels in order to increase the number of smaller cyclones within enclosed space 108.

Airflow enters multi-cyclone unit 106 via an inlet 116 at a level above the lower tube of the smaller cyclones 108a, 108b, etc. Entering airflow is distributed effectively to the multicyclones within a collecting chamber 402. Clean air exits through outlet 410 located at the top or at an upper portion of the multi-cyclone unit 106. Waste particles may be removed through an opening 412 which may be connected to a sump compartment with a hatch to open and remove the waste particles from the multi-cyclone unit 106.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention.

1. A vacuum unit comprising:
a debris tank receiving wet or dry waste;
a multi-cyclone separator coupled to an outlet of the debris tank, the multi-cyclone separator receiving the wet or dry waste from the debris tank, the multi-cyclone separator including a plurality of cyclones, the multi-cyclone separator having a cylindrical shape;
a particle filter coupled to an outlet of the multi-cyclone separator, the particle filter receiving exhaust airflow from the multi-cyclone, the particle filter being suitable for use in wet waste applications; and
a blower coupled to an outlet of the particle filter, the blower venting the exhaust airflow external to the vacuum unit.

2. The vacuum unit of claim 1 further comprising a second multi-cyclone separator, the second multi-cyclone separator coupled between the outlet of the multi-cyclone separator and the particle filter.

3. The vacuum unit of claim 1 further comprising a second multi-cyclone separator, the second multi-cyclone separator coupled in parallel to the multi cyclone.

4. The vacuum unit of claim 1 wherein the plurality of cyclones are fixed at different heights within the multi-cyclone separator, the different heights allowing for an increase in a larger number of the plurality of cyclones to be included in the multi-cyclone separator than if the plurality of cyclones were fixed at the same height.

5. The vacuum unit of claim 1 wherein the plurality of cyclones are fixed at a plurality of heights within the multi-cyclone separator, the plurality of heights allowing for an increase in a larger number of the plurality of cyclones to be included in the multi-cyclone separator than if the plurality of cyclones were fixed at the same height.

6. A vacuum unit vehicle comprising:
a vehicle, the vehicle having a vacuum unit mounted thereon, the vacuum unit comprising:
debris tank receiving wet or dry waste;
a multi-cyclone separator coupled to an outlet of the debris tank, the multi-cyclone separator receiving the wet or dry waste from the debris tank, the multi-cyclone separator including a plurality of cyclones, the multi-cyclone separator having a cylindrical shape;
a filter coupled to an outlet of the multi-cyclone separator, the filter receiving exhaust airflow from the multi-cyclone, the particle filter being suitable for use in wet waste applications; and
a blower coupled to an outlet of the particle filter, the blower venting the exhaust airflow external to the vacuum unit.
